(19) United States
(12) Patent Application Publication
(10) Pub. No.: US 2015/0159435 A1
(43) Pub. Date: Jun. 11, 2015

(54) Steady Step

(71) Applicant: Carlos Vela, Falfurrias, TX (US)

(72) Inventor: Carlos Vela, Falfurrias, TX (US)

(21) Appl. No.: 14/499,844

(22) Filed: Sep. 29, 2014

Related U.S. Application Data
(60) Provisional application No. 61/884,554, filed on Sep. 30, 2013.

(51) Int. Cl. E06C 7/44

(52) U.S. Cl. CPC E06C 7/44

(57) ABSTRACT

The present invention describes a universal replacement cap for a ladder. The device includes a pair of stabilizers set at the base of a ladder that are constructed of a molded insert with a top and a base. The base portion includes a rigid, grooved structure, and the top includes a protrusion. The protrusion includes a central aperture to accept the leg of a ladder. The use of the device improves the stability of a ladder. The device further aids a ladder from sinking into or shifting on a soft surface, such as soil, by increasing the area of the base of the ladder leg. The composition of the present invention is a rigid polymer that prevents scuff marks or damaging surfaces such as wood. In use, the present invention is a temporary addition to a foot ladder, thereby eliminating the hassle of cleaning ladder legs and also enabling the device to be used with multiple ladders.

### PRIORITY

The present invention claims priority based on 35 USC section 119 and application 61/884,554 which was filed on Sep. 30, 2013.

### FIELD OF THE INVENTION

The present invention relates to stabilizing devices and more particularly to a ladder stabilizing device.

### BACKGROUND

May injuries are caused by people falling off of unstable ladders. Ladders can be especially dangerous or difficult to maneuver on soft surfaces, such as soil. Ladders also tend to sink into the soil or other terrain, which can affect the height of the ladder, increase the effort needed when using the ladder, and leave the feet of the ladder muddy. Cleaning the feet of a ladder can be tedious and frustrating. Additionally, when a ladder is used on wood or another vulnerable surface, it can scratch and scuff the floor.

Devices are known in the prior art that relate to ladder stabilizers. The most similar patent located discloses a ladder stabilizer with a U-shaped ladder receiver and an enlarged footprint. This device, however, does not utilize a sleeve that secures the stabilizer to the ladder.

### SUMMARY

A ladder stabilizer to stabilize a ladder may include a top section configured to cooperate with a bottom leg of the ladder and a bottom section connected to the top section and configured to increase the stability of the ladder.

The top section may have a rectangular cross-section.

The top section may have a circular cross-section.

The top section may be angled from 90° with respect to the bottom section.

The top section may be positioned at 90° with respect to the bottom section.

A bottom surface of the bottom section may be uneven.

### BRIEF DESCRIPTION OF THE DRAWINGS

FIG. 1 shows various views of a square embodiment of the present invention.

FIG. 2 (a-d) shows various views of a round embodiment of the preset invention.

FIG. 3 (a-d) shows the present invention in use.

FIG. 4 (a-c)shows various views of the present invention in use.

FIG. 5 shows a perspective view of an alternate embodiment of a stacking version of the present invention.

FIG. 6 (a-c) illustrates a top and side view of the ladder stabilizer of the present invention;

FIG. 7 (a-c) illustrates a top and side view of the ladder stabilizer of the present invention;

FIG. 8 (a-c) illustrates a top and side view of the ladder stabilizer of the present invention.

### DETAILED DESCRIPTION OF THE INVENTION

Referring now to FIG. 2(a-d), there are shown multiple views of a square embodiment of the present invention. The present invention is a molded insert for use with a ladder's legs. In the present embodiment, the device includes a top section 110 and a bottom section 112. The top section 110 is a square elongated member with a central aperture 109 having a front wall 103, a back wall 105 opposing the front wall 103 and a pair of opposing side walls 107 connecting the front wall 103 and the back wall 105. The aperture 109 is used to accept a ladder's leg therein. The front wall 103, the sidewalls 107 and the back wall 105 which may form a sleeve may cooperate with the leg of the ladder by forming a friction fit or close fit between the top section and the leg of the ladder. Additionally, the top section 110 including the aperture 109 which has a rectangular cross-section is slightly angled with respect to the bottom section 112 to more easily accept the ladder's leg and to prevent issues placing the present invention safely onto a surface. Other cross-sections are within the scope of the present invention. The bottom section 112 is a planar platform with a rigid base. The base may include striations, bumps, or other protrusions which may be formed on the bottom surface of the bottom section 112 and may be shown as element 114 to help anchor the ladder stabilizer 100 on a surface.

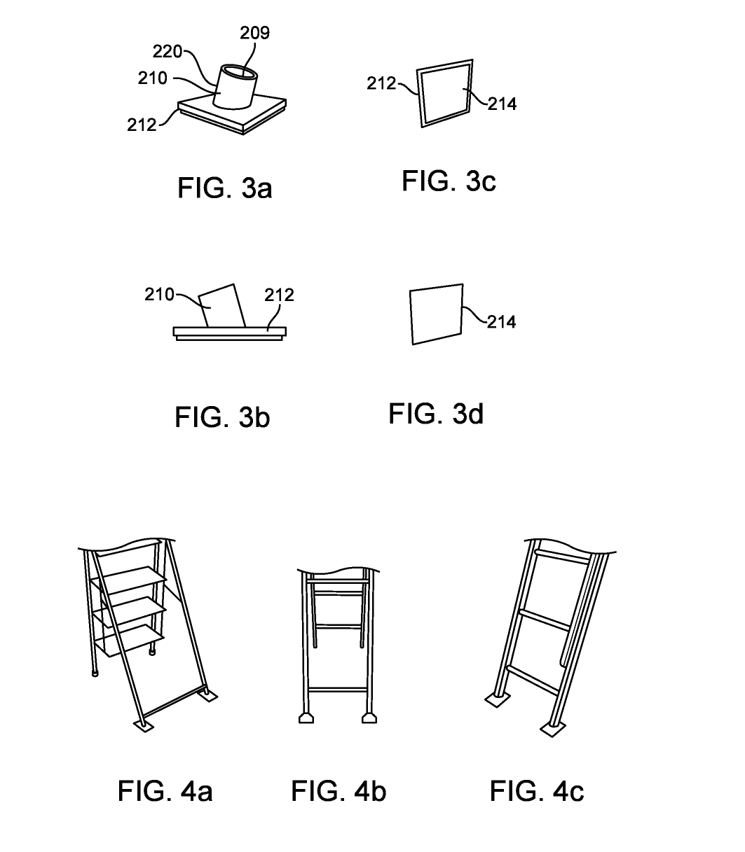

Referring now to FIG. 3(a-d), there are shown multiple views of a round embodiment of the present invention. The top section 210 of this embodiment includes a cylindrical tube 220 having a central aperture 209 having a circular cross-section to form another sleeve. The cylindrical shape of the top section 210 is better suited for use with ladders or stepping stools that do not use a square or rectangular leg and may be configured to accept the legs of the ladder to achieve a friction or a nonmoving fit. The bottom section 212 is a planar platform with a rigid base. The base may include an uneven surface such as striations, bumps, or other protrusions to help anchor the ladder stabilizer 100 on a surface shown as element 214. The top section 210 may be angled with respect to the bottom section 212.

This embodiment would be ideally suited for devices such as stepping stools or stepping ladders where cylindrical legs are more prevalent.

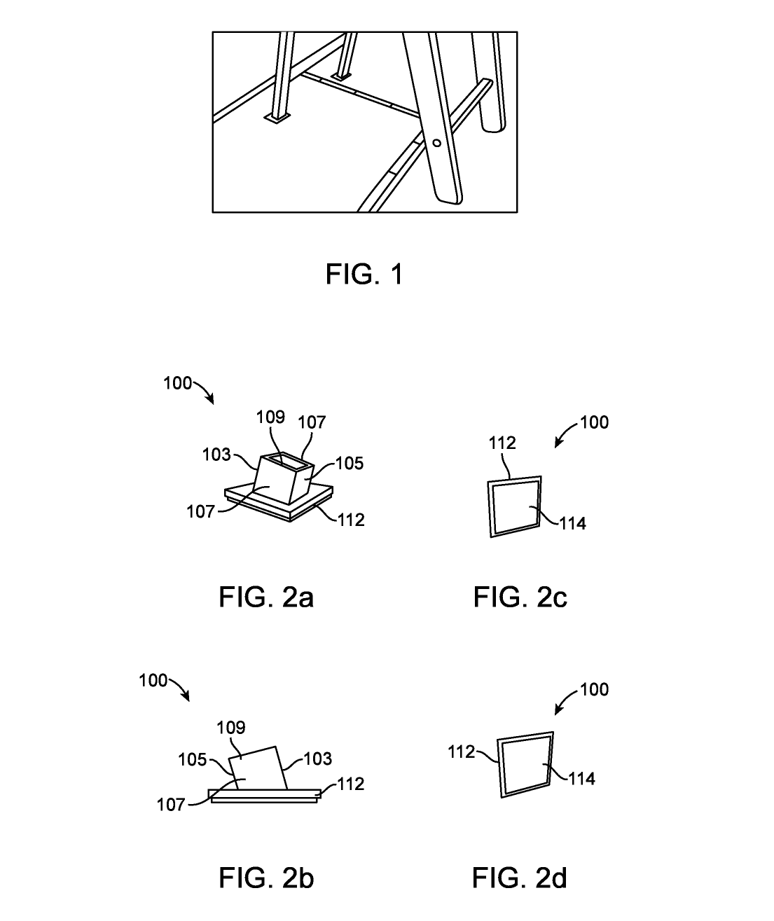

Referring now to FIG. 1, there is shown a view of the present invention in use. In most common scenarios, the present invention is attached to either side of a standard ladder. Most ladders do have a stability means or some form of friction causing means (usually on the bottom legs of the ladder) on one pair of legs. The other pair of legs (top legs) of the ladder tends to be smaller and do not have as large an area at the respective base of each ladder leg. The use of the present invention substantially increases the surface area of those ladder legs and helps to stabilize the ladder prior to use. Referring now to FIG. 4(a-c), there are shown multiple views of the present invention in use while attached to the legs (bottom or top) of a ladder. In addition to the use of the present invention to support a four-legged ladder, it can also be utilized with a ladder that has only two legs. Just as with the use on a conventional four-legged ladder, the present invention increases the stability of the ladder. Further, the base of each leg increases the area it comes into contact with at the surface, has a greater friction causing base, and becomes further anchored to the surface it is in contact with.

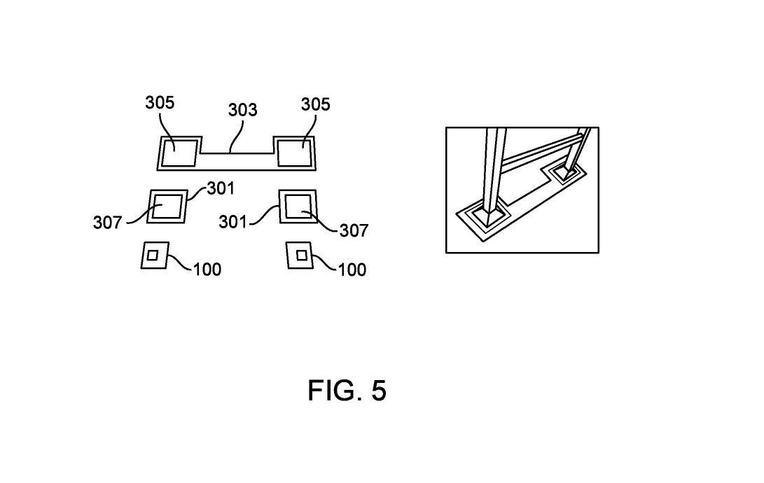

Referring now to FIG. 5, there is shown a stacking version of the present invention. This embodiment includes a secondary base 301 to increase the area of contact with the surface and an elongated section 303. The secondary base 301 cooperates by forming a friction fit with a cavity 305 formed within the elongated section 303. The secondary base 301 cooperates with the ladder stabilizer 100 by forming a friction fit formed within a cavity 307 of the secondary base 301. The ladder stabilizer 100 cooperates with the legs of the ladder as described above. The elongated section 303 increases the surface area of the present invention when in contact with the poor supports surface ground and aligns the two latter stabilizers 100 to have the legs uniformly set against the ground or support surface. The secondary base 301 may be used with or without the elongated section 303.

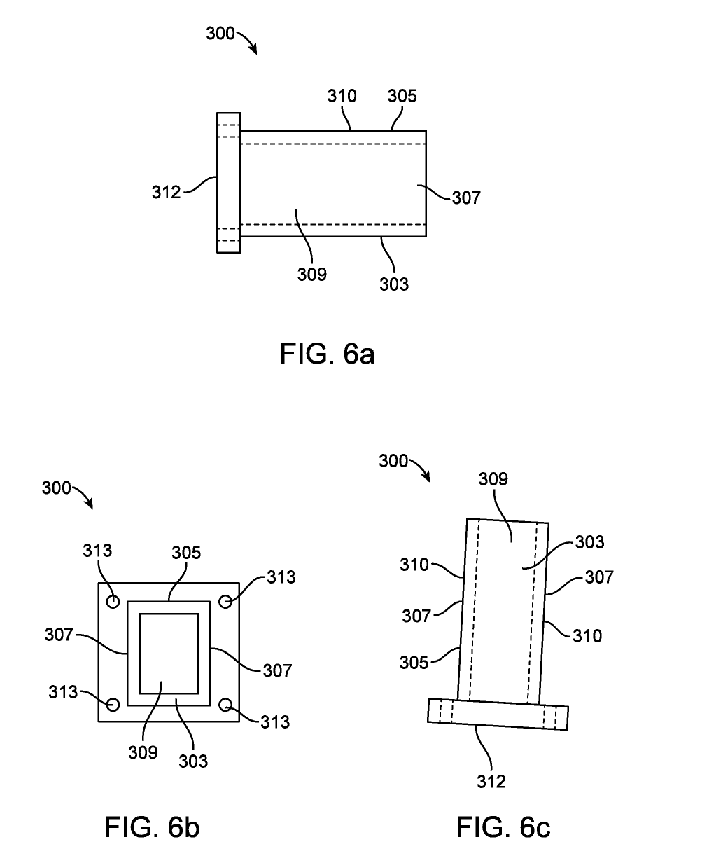

FIG. 6 a-c illustrates another ladder stabilizer 300 of the present invention and illustrates a top section 310 and a bottom section 312. The top section 310 may include a front wall 303, a back wall 305, a sidewall 307 and a central aperture 309. The bottom section 312 may include apertures 313 to accommodate fasteners (not shown) to connect the bottom section 312 to the support surface (not shown).

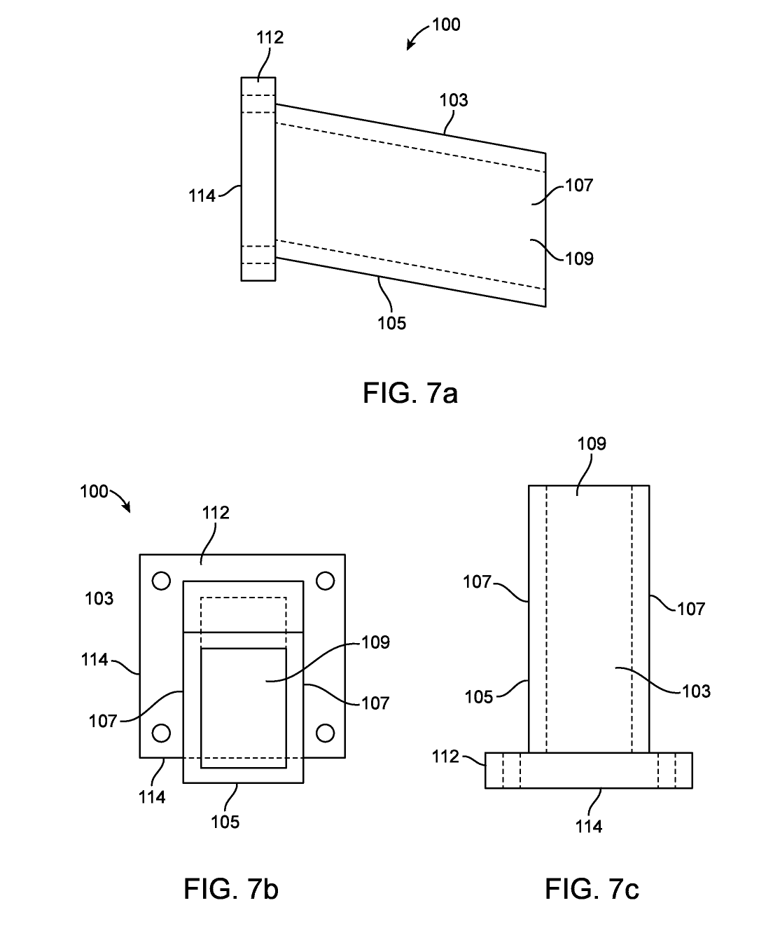

Referring now to FIG. 7(a-c), there are shown multiple views of a square embodiment of the present invention. The present invention is a molded insert for use with a ladder's legs. In the present embodiment, the device includes a top section 110 and a bottom section 112. The top section 110 is a square elongated member with a central aperture 109 having a front wall 103, a back wall 105 opposing the front wall 103 and a pair of opposing side walls 107 connecting the front wall 103 and the back wall 105. The aperture 109 is used to accept a ladder's leg therein. The front wall 103, the sidewalls 107 and the back wall 105 which may form a sleeve may cooperate with the leg of the ladder by forming a friction fit or close fit between the top section and the leg of the ladder. Additionally, the top section 110 including the aperture 109 which has a rectangular cross-section is slightly angled with respect to the bottom section 112 to more easily accept the ladder's leg and to prevent issues placing the present invention safely onto a surface. Other cross-sections are within the scope of the present invention. The bottom section 112 is a planar platform with a rigid base. The base may include striations, bumps, or other protrusions which may be formed on the bottom surface of the bottom section 112 and may be shown as element 114 to help anchor the ladder stabilizer 100 on a surface.

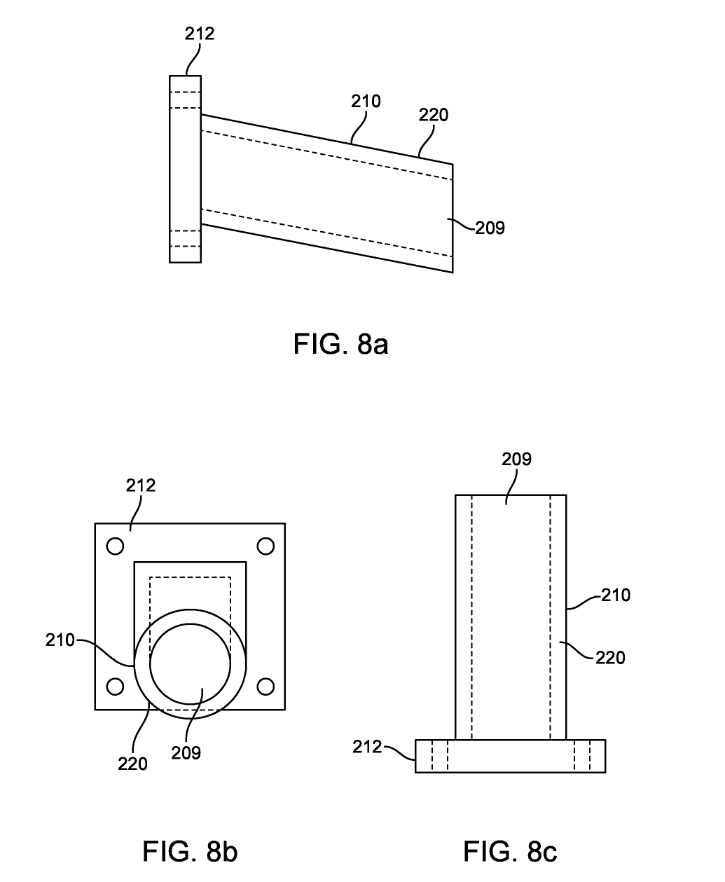

Referring now to FIG. 8(a-c), there are shown multiple views of a round embodiment of the present invention. The top section 210 of this embodiment includes a cylindrical tube 220 having a central aperture 209 having a circular cross-section to form another sleeve. The cylindrical shape of the top section 210 is better suited for use with ladders or stepping stools that do not use a square or rectangular leg and may be configured to accept the legs of the ladder to achieve a friction or a nonmoving fit. The bottom section 212 is a planar platform with a rigid base. The base may include an uneven surface such as striations, bumps, or other protrusions to help anchor the ladder stabilizer 100 on a surface shown as element 214. The top section 210 may be angled with respect to the bottom section 212.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

What is claimed is:

1. A ladder stabilizer to stabilize a ladder, comprising:
a top section configured to cooperate with a bottom leg of the ladder;
a bottom section connected to the top section and configured to increase the stability of the ladder.

2. A ladder stabilizer to stabilize a ladder as in claim 1, wherein the top section has a rectangular cross-section.

3. A ladder stabilizer to stabilize a ladder as in claim 1, wherein the top section has a circular cross-section.

4. A ladder stabilizer to stabilize a ladder as in claim 1, wherein the top section is angled from 90° with respect to the bottom section.

5. A ladder stabilizer to stabilize a ladder as in claim 1, wherein the top section is positioned at 90° with respect to the bottom section.

6. A ladder stabilizer to stabilize a ladder as in claim 1, wherein the bottom surface of the bottom section is uneven.
